(19) United States
(12) Patent Application Publication
(10) Pub. No.: US 2025/0321987 A1
(43) Pub. Date: Oct. 16, 2025

(54) INCORPORATING NON-TEXT CUES FOR MACHINE LEARNING REFERENTIAL DIALOGUE

(71) Applicant: International Business Machines Corporation, Armonk, NY (US)

(72) Inventors: Zhong Fang Yuan, Xi'an (CN); Tong Liu, Xi'an (CN); Yuan Yuan Ding, Shanghai (CN); Li Juan Gao, Xi'an (CN)

(21) Appl. No.: 18/632,482

(22) Filed: Apr. 11, 2024

(51) Int. Cl. G06F 16/332; G06T 7/11; G06V 20/70

(52) U.S. Cl. CPC G06F 16/3329; G06T 7/11; G06V 20/70

(57) ABSTRACT

A computer system, method, and program product facilitate human-computer interaction. A processor set receives a non-text visual cue and natural language instruction regarding a scene. The processor set converts the non-text visual cue into a textual location information indicating a portion of an image representing the scene. A language machine learning model is triggered by using the textual location information, the natural language instruction, and the image representing the scene as input. The language machine learning model outputs a response to the input.

### BACKGROUND

The present application relates generally to computers, computer applications, machine learning models, and using machine learning models for question answering regarding images.

### BRIEF SUMMARY

The summary of the disclosure is given to aid understanding of a computer system and method of referential dialogue, for example, a large language model based reference dialogue approach combining relative semantic information and positional information, and not with an intent to limit the disclosure or the invention. It should be understood that various aspects and features of the disclosure may advantageously be used separately in some instances, or in combination with other aspects and features of the disclosure in other instances. Accordingly, variations and modifications may be made to the computer system and/or their method of operation to achieve different effects.

In some embodiments, a computer-implemented method includes receiving, by a processor set, a non-text visual cue and natural language instruction regarding a scene. The computer-implemented method also includes converting, by the processor set, the non-text visual cue into textual location information indicating a portion of an image representing the scene. The computer-implemented method also includes triggering running of a language machine learning model using as input at least the textual location information, the natural language instruction, and the image representing the scene. The language machine learning model outputs a response to the input.

In some embodiments, a computer system is provided that includes a processor set, a set of one or more computer-readable storage media, and program instructions, collectively stored in the set of one or more computer-readable storage media, for causing the processor set to perform computer operations of the method described herein.

In some embodiments, a computer program product is provided that includes a set of one or more computer-readable storage media, and program instructions, collectively stored in the set of one or more storage media, for causing a processor set to perform computer operations of the method described herein.

Further features as well as the structure and operation of various embodiments are described in detail below with reference to the accompanying drawings. In the drawings, like reference numbers indicate identical or functionally similar elements.

### BRIEF DESCRIPTION OF THE DRAWINGS

FIG. 1 shows an example of a computing environment, which can implement referential dialogue according to some embodiments.

FIG. 2 illustrates an example scenario of interacting with a large language model according to some embodiments.

FIG. 3 is a diagram illustrating an interaction between large language models and humans in terms of actions or locations according to some embodiments.

FIG. 4A is a diagram illustrating a location understanding phase according to some embodiments.

FIG. 4B is a diagram illustrating creation of training data that can subsequently be used to train a machine learning model for referential dialogue according to some embodiments.

FIG. 5 is a diagram illustrating training of a large language model according to some embodiments.

FIG. 6 is a diagram illustrating a position representation for a large language model according to some embodiments.

FIG. 7 is a diagram illustrating pointer generation according to some embodiments.

FIG. 8 is a flow diagram illustrating a method of referential dialogue according to some embodiment.

### DETAILED DESCRIPTION

A computer-implemented method is provided, for example, for referential dialogue in some embodiments. A computer-implemented method includes receiving, by a processor set, a non-text visual cue and natural language instruction regarding a scene. The computer-implemented method also includes converting, by the processor set, the non-text visual cue into a textual location information indicating a portion of an image representing the scene. The computer-implemented method also includes triggering running of a language machine learning model using as input at least the textual location information, the natural language instruction, and the image representing the scene. The language machine learning model outputs a response to the input.

In this way, improved referential dialogue with a machine learning model for human-computer interaction is achieved as the model(s) are able to better respond to inquiries due to recognition and understanding of supplementary information provided in form of the non-text visual cues.

One or more of the following features can be separable or optional from each other. In the method, in some embodiments, the non-text visual cue includes a bounding box in the image representing the scene. The converting of the non-text visual cue into a textual location information includes running a machine learning model that associates the bounding box with semantic information obtained for an area contained in the bounding box and that outputs location coordinates of the bounding box with respect to the image.

In this way, artificial intelligence is used to pre-process non-textual visual information such as a bounding box overlaid on an image, and convert same into textual information that is more processible by a language machine learning model.

In some embodiments, the non-text visual cue includes a pointer pointing to an area of the scene and the converting of the non-text visual cue into a textual location information includes the following computer operations: determining a bounding box that bounds the area of the scene pointed to by the pointer; and running a machine learning model that associates the bounding box with semantic information obtained for an area contained in the bounding box and that outputs location coordinates of the bounding box with respect to the image.

In this way, artificial intelligence is used to pre-process non-textual visual information such as a pointer information from a pointing device, and convert same into textual information that is more processible by a language machine learning model.

In some embodiments, the language machine learning model includes an image encoder and a text encoder, the language machine learning model having been trained based on first embeddings encoded by the image encoder and second embeddings encoded by the text encoder to relate semantic information appearing in sample images to location information incorporated in sample natural language instructions associated with the sample images.

In this way, machine learning architecture is utilized and trained to allow improved machine learning responses to inputs that include both an image and textual description of the image.

In some embodiments, the machine learning model includes an image segmentation model that segments objects in a given image, correlates bounding boxes of the segmented objects in the given image with respective textual location coordinates of the bounding boxes, and outputs a descriptive text describing the segmented objects via the textual location coordinates.

In this way, for example, image segmentation machine learning is utilized to better help machine learning models respond to inquiries based on images.

In some embodiments, the non-text visual cue is obtained via a human-computer interaction performed via a smartphone. In this way, access to machine learning models for using same for gaining knowledge is provided at a local convenient level.

In some embodiments, the response is an answer to a question of the input. In this way, artificial intelligence is used to facilitate users acquiring knowledge related to images.

In some embodiments, a computer program product is provided that includes a set of one or more computer-readable storage media, and program instructions, collectively stored in the set of one or more storage media, for causing a processor set to perform computer operations of the method described herein.

In some embodiments, a computer system is provided that includes a processor set, a set of one or more computer-readable storage media, and program instructions, collectively stored in the set of one or more computer-readable storage media, for causing the processor set to perform computer operations of the method described herein.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as referential dialogue algorithm code 200. In addition to referential dialogue algorithm code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and referential dialogue algorithm code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

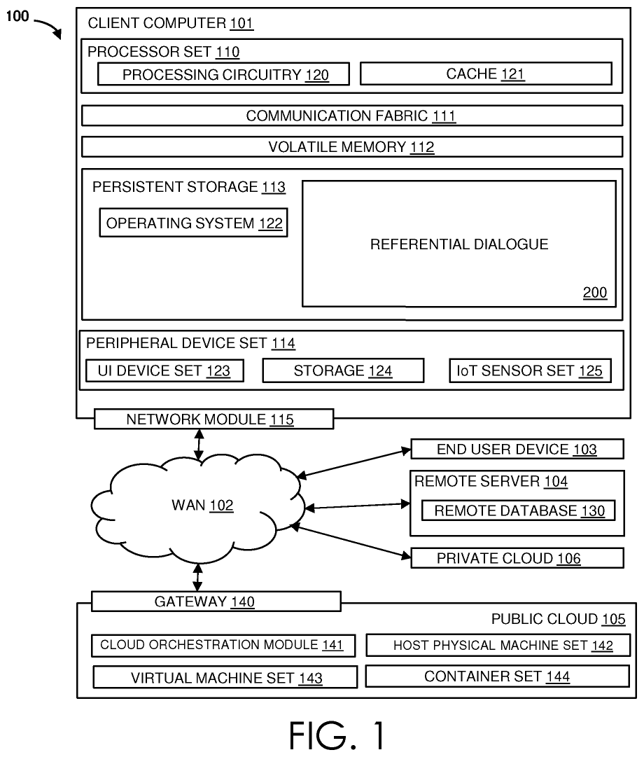

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in referential dialogue algorithm code 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in referential dialogue algorithm code 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

A large language model is a machine learning model that is built or trained to understand natural language as well as generate text in natural language. Large language model architecture includes artificial neural networks and also can be in a form of a generative neural network. Large language models (LLMs) are a category of foundation models (machine learning models) trained on immense amounts of data making them capable of understanding and generating natural language and other types of content to perform a wide range of tasks. LLMs are an implementation of artificial intelligence and, more particularly, generative artificial intelligence. LLMs have natural language understanding (NLU) and natural language processing (NLP) capabilities. Machine learning, machine learning models, algorithms, neural networks and transformer models provide architecture for LLMs. LLMs are a class of foundation models, which are trained on enormous amounts of data to provide the foundational capabilities needed to drive multiple use cases and applications, as well as resolve a multitude of tasks. LLMs are accessible through interfaces and provide information and/or perform tasks in response to receiving a prompt in natural language. LLMs are designed to understand and generate text like a human, in addition to other forms of content, based on the vast amount of data used to train them. Some features that LLMs have in some embodiments include the ability to infer from context, to generate coherent and contextually relevant responses, to translate text to different human languages, to summarize text, to answer questions (general conversation and FAQs), and to assist in creative writing and/or code generation tasks. The LLMs in some embodiments include billions of parameters that enable them to capture intricate patterns in language and perform a wide array of language-related tasks. LLMs are implementable in various fields, from chatbots and virtual assistants to content generation, research assistance and language translation.

LLMs operate by leveraging deep learning techniques and vast amounts of textual data. These models are in many embodiments based on a transformer architecture, like the generative pre-trained transformer, which handles sequential data like text input. LLMs in many embodiments include multiple layers of neural networks, each with parameters that can be fine-tuned during training, which are enhanced further by a numerous layer known as the attention mechanism, which dials in on specific parts of data sets. During the training process, these models learn to predict the next word in a sentence based on the context provided by the preceding words. The model does this through attributing a probability score to the recurrence of words that have been tokenized-broken down into smaller sequences of characters. These tokens are then transformed into embeddings, which are numeric representations of this context.

To ensure accuracy, this process involves training the LLM on a massive corpora of text (e.g., in the billions of pages), allowing the LLM to learn grammar, semantics and conceptual relationships through zero-shot and self-supervised learning. Once trained on this training data, LLMs can generate text by autonomously predicting the next word based on the input they receive, and drawing on the patterns and knowledge they have acquired. The result is coherent and contextually relevant language generation that can be implemented for NLU and content generation tasks. Model performance can also be increased through prompt engineering, prompt-tuning, fine-tuning and other tactics like reinforcement learning with human feedback (RLHF).

Some forms of communication involve focusing on different areas or objects in a scene. For example, parties in communication may verbally express and point to certain areas or objects in a scene to achieve efficient information exchange. This mode of conversation is called referential dialogue or location prompting. When using a large language model, interactivity in referential dialogue is relatively simple, usually only handling the input of prompts in the form of text; That is, language models do not interact with humans in a way smartphones or other terminal devices do.

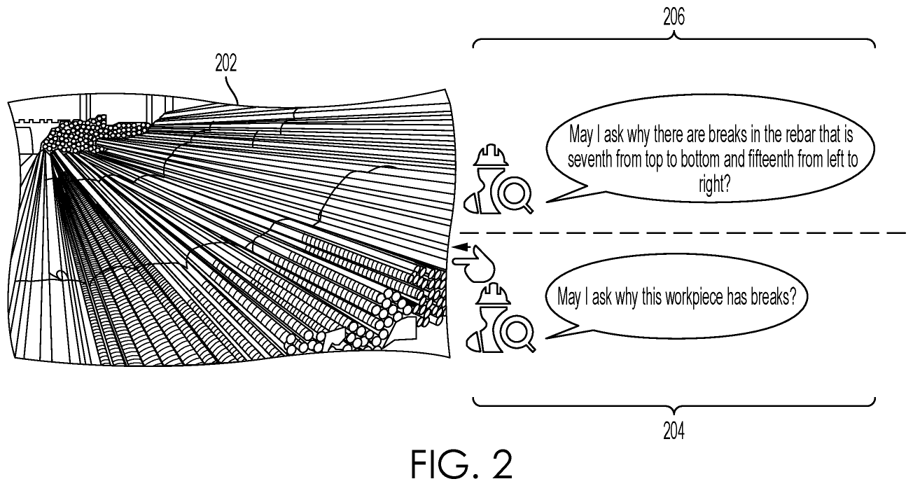

In real world scenarios, the information that needs to be provided to large language models is often immediate or difficult to express concisely in text form. Consider the following examples. When using video or augmented reality (AR) devices for workpiece quality inspection, a user may often want to directly ask if a workpiece is defective. A direct way to do this is to gesture or point, for example, using a finger, mouse, or line of sight (using hardware such as mixed reality glasses) at the workpiece in question, and ask the language model (e.g., a computer running a large language model). For example, a user may want to ask a large language model (e.g., a computer or bot or like device running a large language model), “Why is this workpiece broken?”, instead of using a lengthy text prompt such as, “Why does the rebar count seventh from the top and fifteenth from left to right have breaks?” FIG. 2 illustrates this example scenario. Given an image of a scene 202, it would be more convenient to the user to simply pose a question to a large language model by pointing to an area in question in the image as shown at 204, instead of textually providing the location description of an area in question as shown at 206. As another example, consider a text review process, where a user would simply draw an area with a finger or mouse and give a command to the large language model: “Please help me summarize the important points of this text.” This is much more concise than using a complex prompt text. Yet as another example, when comparing different invoices or purchase orders, a user may want to point a finger (or another pointer) at different invoices and give instructions, such as: “Please help me compare this invoice with that invoice.” In some embodiments, systems and methods are disclosed that improve large language models to better able to interact with humans, specifically to understand actions performed by humans or locations indicated by humans on the basis of information received in real-time or in non-textual form. These improvements help the model-human interactions to occur more efficiently in real world scenarios.

In some embodiments, a system and/or method includes a location understanding process, an indicator generation, and an interaction optimization process. In a location understanding process or phase, the system and/or method introduces a visual processing module (e.g., a visual processing function or functionality) and a text processing module (e.g., a text processing function or functionality) to process an input. The visual processing module receives the location information collected from devices such as cameras, augmented reality (AR) devices or other image sensors, and performs object detection, feature extraction and/or other processing techniques to obtain the location information of objects in the scene. The text processing module receives instructions in verbal or written form and converts the instructions in verbal or written form into corresponding semantic representations.

In a pointer generation phase, based on the results of location understanding, the system and/or method utilizes a generation module to generate appropriate pointer information. The generation module (or function) combines location information with semantic representation to generate pointer information that guides a large language model's attention to specific areas. This can be textual pointers (such as displaying coordinates or keywords in a text interface) or action-based pointers (such as directing the large language model toward an object through gaze or gestures in AR devices).

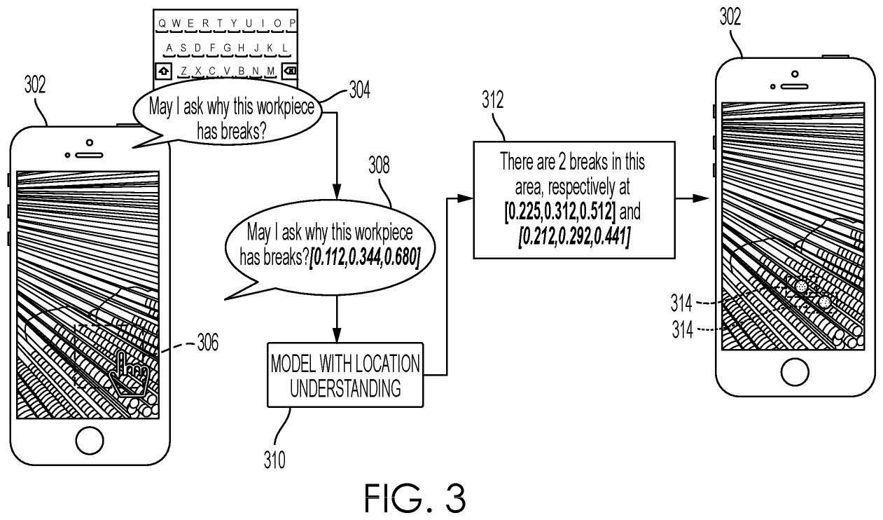

FIG. 3 is a diagram illustrating an interaction between large language models and humans in terms of actions or locations in some embodiments. A smartphone 302 may be running a large language model in some embodiments. By employing the above two phases, the system and/or method can enhance the interaction between large language models and humans in terms of actions or locations. This can greatly improve the efficiency and convenience of utilizing real-time and/or non-textual information in commercial scenarios. For example, an interaction includes a text instruction or question 304 and a box or pointer area 306 in an image. The text instruction or question is then converted to text instruction with embedded location information 308. The converted text instruction with embedded location information is given to a large language model trained with location understanding 310. This input causes the large language model to generate an answer 312 and to provide and associate a visual indication 314 with the answer 312.

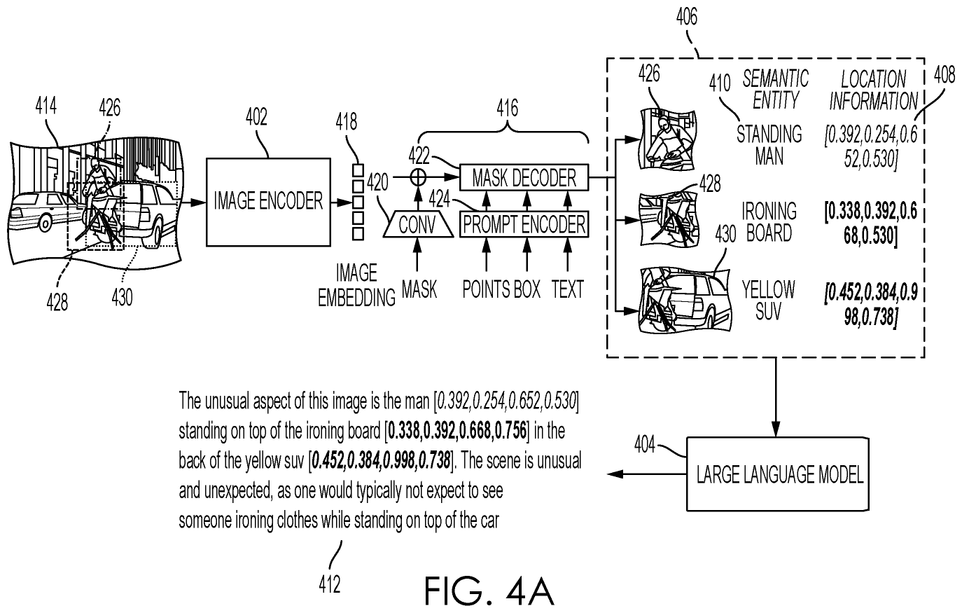

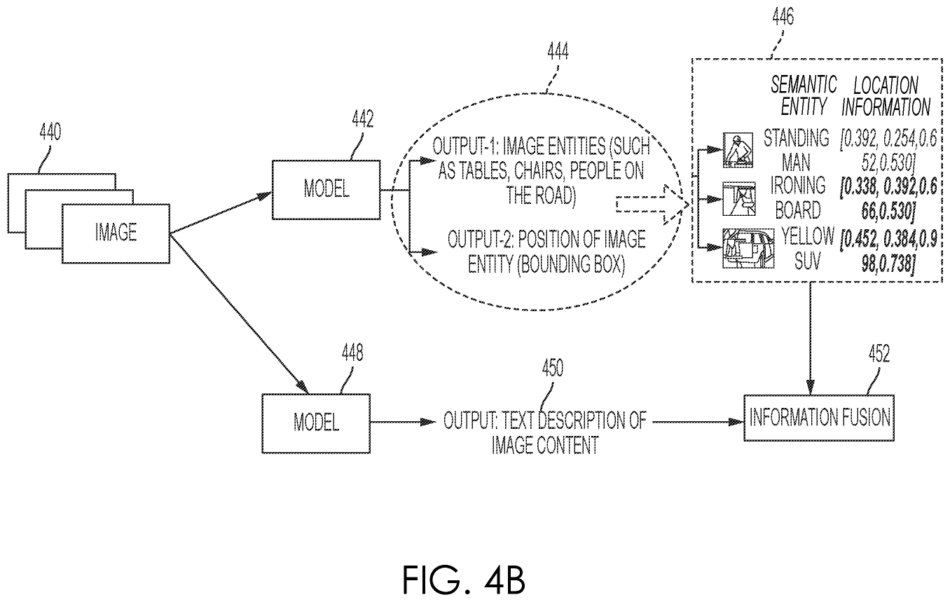

FIG. 4A is a diagram illustrating a location understanding phase according to some embodiments. In the location understanding phase, the system and/or method uses an image segmentation model such as Segment Anything Model (SAM) from Meta AI, Astor Place, New York City, New York, U.S, to determine the visual semantic information and location information in an image or video. The system and/or method uses the visual semantic information and location information determined, e.g., using such segmentation model, as input of this location understanding module or phase. The location understanding module processes the input using the Document Visual Question Answering (DOC_VQA) method to obtain the location information and simultaneously convert it into a text representation. The aforementioned steps extract visual semantic units from images or videos and convert them into a “rich entity” data structure including textual representations of semantic entities along with their positional information as shown at 406. These semantic entities are then organized into a predominantly descriptive text. As shown at 412, the positional information of each semantic entity is appended to its description. In some embodiments, the system and/or method directly utilizes numerical values from natural language to represent object positions, using [xmin, ymin, xmax, ymax] to denote bounding boxes. In some embodiments, an image segmentation model includes one encoder and two decoders, for example, image encoder 402 and decoders 416. Image encoder 402 encodes an image 414 into an embedding 418, e.g., vectors. Convolution network 420, mask decoder 422 and prompt encoder 424 bound semantic information 410 and location information 408 of objects identified in the embedding 418, as shown at 406. A model such as large language model 404 generates a descriptive text 412 about the image 414, where the descriptive text 412 includes location information of bounding boxes of objects identified in the image 414, for example, as shown in square brackets at 412. For example, bounding box at 426 having location information of [0.392, 0.254, 0.652, 0.530] is identified with “standing man”, bounding box at 428 having location information of [0.338, 0.392, 0.668, 0.530] is identified with “ironing board” and bounding box at 430 having location information of [0.452, 0.384, 0.998, 0.738] is identified with “yellow SUV” in image 414. An example implementation of the large language model 404 can be WizardLM-13B V1.0 from Microsoft Corporation, Redmond Washington.

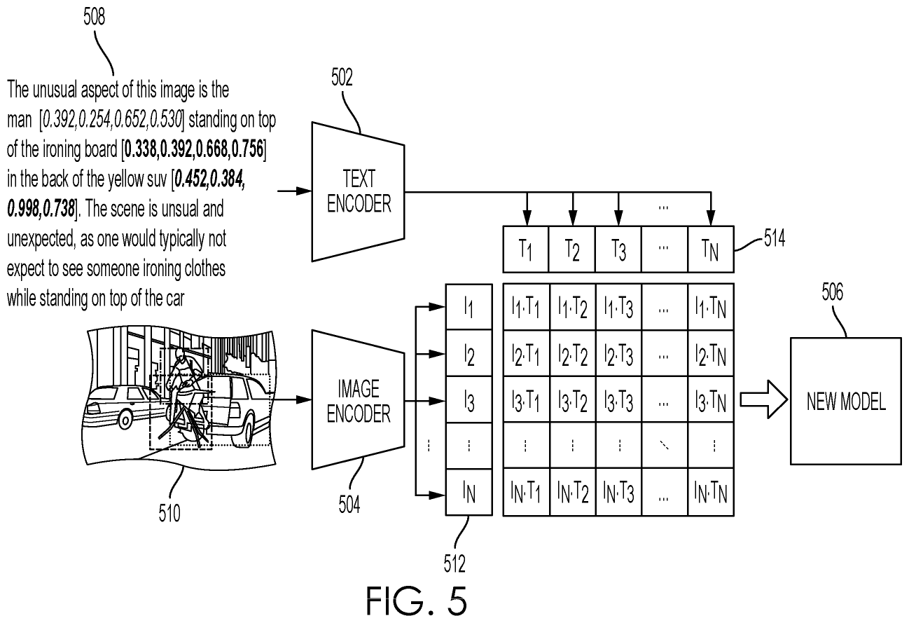

FIG. 4B is a diagram illustrating creation of training data that can subsequently be used to train a machine learning model for referential dialogue according to some embodiments. A preliminary training set includes images 440, for example, image data, an example of which is shown at 414 in FIG. 4A. Multiples of images are used in training for outputting corresponding text description with location information (an example of which is shown at 412 in FIG. 4A). For training, an image 440 in the training set is input to a model 442. An example of the model 442 is shown in FIG. 4A at 402, 418, 416. For example, as described above, an image segmentation model such as SAM can be used. The model 442 performs preliminary semantic entity extraction and location information extraction on the image 440. As shown at 444, the model outputs image entities (such as tables, chairs, people on the road, etc.) and the positions (location information or coordinates) of the corresponding image entities appearing in the image 440. These two outputs can be integrated such as at integration 446 where each segmented element is associated with its name and with its corresponding textual location information. In FIG. 4A this integration 446 is shown as a chart with the three entries for each segmented element. The image 440 is also input to another machine learning model 448 that outputs a text description of the image content 450. This model 448 is an image analysis model according to some embodiments. An example of such text description may be “The unusual aspect of this image is the man standing on top of the ironing board in the back of the yellow SUV. The scene is unusual and unexpected, as one would typically not expect to see someone ironing clothes while standing on top of the car.” An example implementation of the model 448 can be a large language model (LLM) such as WizardLM-13B V1.0. Information fusion 452 takes as input, the location information of the semantic entities generated or output by the model 442 and the text description of the image content generated or output by the model 448, and enhances or supplements the text description of the image content with the location information. An example operation is to replace the semantic entity appearing in plain text in the text description with semantic entity+location information. For example, “the man” is replaced with “the man [0.392,0.254,0.652,0.530]”. An example of the results of this operation or fusion is shown at 412 in FIG. 4A and at 508 in FIG. 5 described below.

FIG. 5 is a diagram illustrating training of a large language model in some embodiments. In some embodiments, by way of example, the system and/or method may use a ViT-L/14 (from OpenAI, San Francisco, California) pre-trained model (image and text model) from Contrastive Language-Image Pretraining (CLIP) as a visual or image encoder and WizardLM-13B V1.0 as a large language model (LLM). For example, the pre-trained model includes text encoder 502 and image encoder 504. Model 506 is trained to associate text information from the text encoder 502 with image information from the image encoder 504. In some embodiments, the image encoder 504 is the ViT-L/14 pre-trained model. In some embodiments, the text encoder 502 is a language machine learning model such as a large language model (LLM) such as WizardLM-13B V1.0. For example, model 506 is trained to connect or relate text information with image information. In some embodiments, the system and/or method utilizes a fully connected layer to map the output of ViT-L/14, which is an embedded vector V (with dimensions 16×16×1024) to V′ (with dimensions 256×D) for modality alignment to correct the input dimension for LLM. By way of example, for WizardLM-13B V1.0, used as the LLM, D is set to 5,120. The visual embedding can be inserted at any position in the input sequence. During the training process, both the fully connected layer and the entire language model are involved. In some embodiments, the system and/or method does not introduce any vocabulary or special encoder to encode positional information. Additionally, the system and/or method does not introduce additional pre- or post-detectors to handle points or bounding boxes. Training a large language model uses text encoder 502 that takes text description with positional information of semantic entities 508 as input, and image encoder 504 that takes an image 510 as input. For example, a training data set for training the model 506 includes an image 510 and a descriptive text of the content of the image with location information 508, e.g., the training data generated via the process shown in FIG. 4B. A plurality of images and corresponding descriptive text with location information are used to train the model 506. Generating of such training data set is described above with reference to FIG. 4A and FIG. 4B. For instance, descriptive text with location information 508 for corresponding image 510 can be one that is output by or results from the information fusion component or functionality shown at 452 in FIG. 4B. Given text 508, text encoder 502 encodes text 508 into an embedding 514 (e.g., a vector). Given image 510, image encoder 504 encodes the image 510 into an embedding 512 (e.g., a vector). Model 506 is trained using the embeddings 512, 514, to connect information in text 508 with objects in image 510. After training, the system and/or method obtains model 506 (a new model) that is capable of processing both textual and visual inputs and can provide corresponding bounding box information based on natural language instructions. Bounding box information can be used to identify a meaningful semantic entity in a given image. Model 506 that is trained has the capability to process both text and video (or image) input, and can provide corresponding bounding box information based on natural language instruction. In some embodiments, training of the model 506 can involve contrastive learning. The trained model 506 can well connect semantic, location, and visual information.

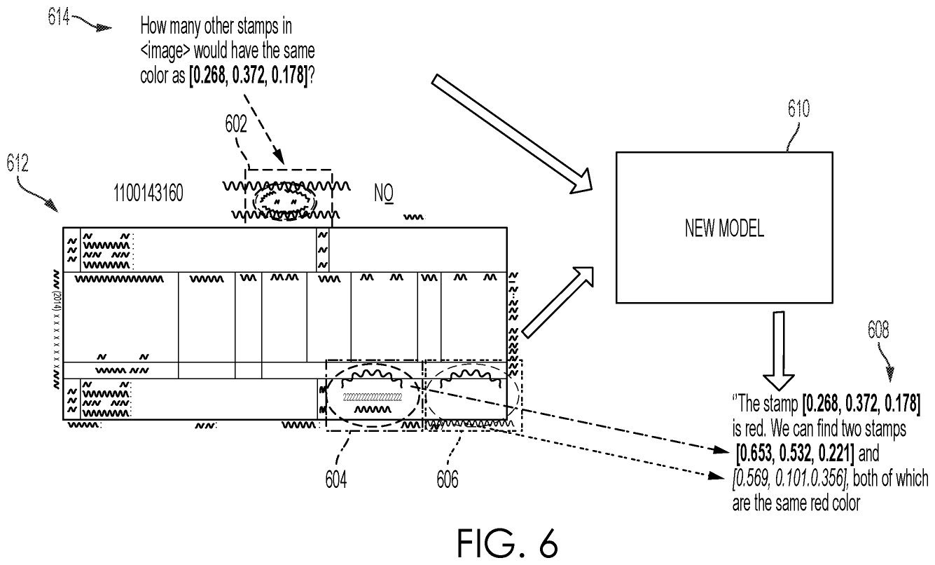

FIG. 6 is a diagram illustrating a position representation for a large language model according to some embodiments. In some embodiments, the system and/or method represents positions in an intuitive manner using numerical values in natural language. The system and/or method uses [xmin, ymin, xmax, ymax] to denote bounding boxes and [xcenter, ycenter] to represent the center point of a region. The values of x and y are normalized based on the size of the image. Each number is by default represented with three decimal places. These coordinates can appear at any position in the input and output sequences of the model. For example, consider that stamp at 602 is represented as [0.268, 0.372, 0.178], stamp at 604 is represented as [0.653, 0.532, 0.221] and stamp at 606 is represented as [0.569, 0.101, 0.356]. Consider also, in this example, the user query: “How many other stamps in <image> have the same color as [0.268, 0.372, 0.178]?” The well-trained model will respond with “The stamp [0.268, 0.372, 0.178] is red. We can find two other stamps, [0.653, 0.532, 0.221] and [0.569, 0.101, 0.356], that are also red. So the answer is two.” For example, a trained model at 610 (e.g., also shown in FIG. 5 at 506 and trained as described above with reference to FIG. 5) takes as input an image of a document shown at 612 and a user query shown at 614 with pointer information, in this example, location information of a bounding box of stamp shown at 602. The pointer information shown with user query at 614 can be obtained based on detecting a mouse pointer location (e.g., pointing to stamp at 602), touch screen finger pointing to that location, eye tracking or gazing to that location, and/or based on detecting other similar pointing devices pointing to the location. The trained model 610 outputs an answer shown at 608. In addition, there can be visual indications to 604, 606 that are provided with the answer 608, e.g., the original image itself is displayed with visual indicators overlaid thereon to help improve the answer 608, e.g., to point to one or more areas which are part of the answer 608. The square brackets naturally appear in the sentence and can function as any part of the sentence. Similar to regular text, they can be tokenized without distinction. The trained model 610 can take pointer information and convert the pointer information into textual location information for allowing seamless human-computer interaction with a machine learning model to facilitate referential dialogue with the machine learning model.

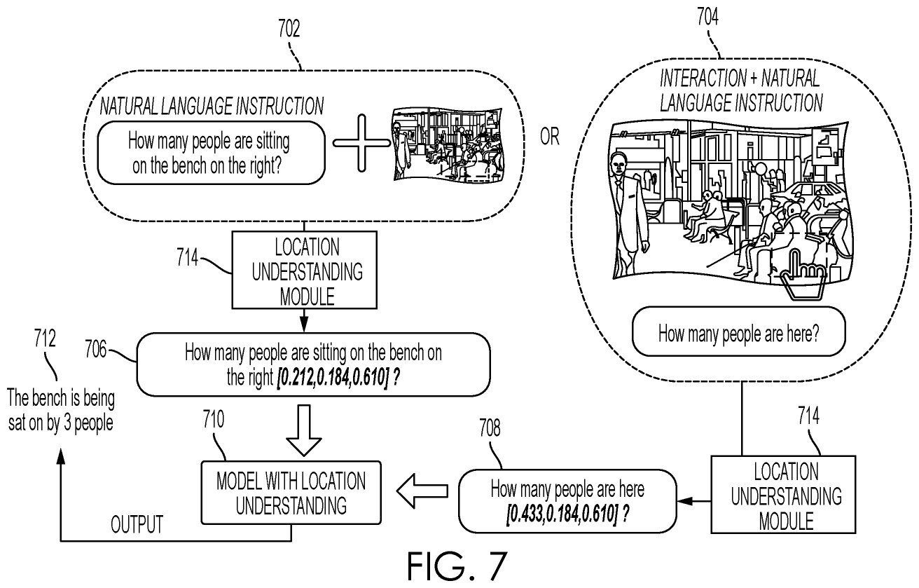

FIG. 7 is a diagram illustrating a full workflow and pointer generation in some embodiments. Pointer generation combines the results of positional understanding and semantic representation to generate appropriate pointing information, enabling the large language model to focus on specific areas or objects. Positional understanding described above constructed a positional understanding model that integrates two inputs: positional information and semantic representation. In pointer generation phase, the system and/or method comprehends user inputs related to point/box and supports the seamless reference dialogue with humans by facilitating point/box outputs. In some embodiments, a model, which the system and/or method built in positional understanding naturally supports standard positional description information due to the inclusion of bounding box information. Therefore, the system and/or method only needs to map the user's point or language instructions in real-time from the terminal device (such as a smartphone, computer, or AR device) to standard positional description information. By incorporating real-time positional interaction information into the input of the model, the system and/or method can achieve directional input for the large language model. The code 200 in some embodiments includes a user-controlled positioning element such as a bounding box and/or a cursor. The user is able to use an input device of a computer to control the position and/or size of the bounding box and/or cursor on a screen that is displaying the image. The code 200 also includes eye tracking in some embodiments such that an element within a displayed image is identified based on viewing angle of an eye of a user who is viewing the image. A camera of a computer such as the computer 101 performs such eye tracking in some embodiments. When a user is satisfied with a position of a cursor and/or a bounding box, a user is able to input an instruction into the computer 101 to actuate the code 200 to perform referential dialogue using a non-text visual cue.

Given a first input 702 that includes a natural language instruction and an image with a bounding box or given a second input that includes a natural language instruction and an image with an interactive pointer 704, the system and/or method converts or transforms the input natural language and bounding box or pointer location into descriptive text with location information 706, 708. For example, as described above with reference to FIG. 4A, descriptive text with location information 706, 708 are generated using the processing of the location understanding phase. An instance of location understanding module 714 transforms the given input (e.g., at 702 or 704) into descriptive text with location information 706, 708.

In another embodiment, the location understanding module 714 includes graphics programming code without a machine learning model. The graphics programming code is able to recognize the position of a bounding box within an image and/or a position of a pointer arrow/cursor being dragged around the image. The graphics programming code is able to use the position recognition to output textual location information that indicates the position/size of the bounding box when an input is actuated and/or the position of the cursor within the screen. The graphics processing code is part of the code 200 in some embodiments. In other embodiments, the graphics processing code is external to the code 200, e.g., as part of a third-party toolkit such as a graphics program, and the code 200 communicates with this external code 200 to obtain the location coordinates of the non-text visual cue. Such communication occurs in some embodiments via an application programming interface of the code 200 and/or of the external graphics program.

Model with location understanding 710 (for example, shown in FIG. 5 at 506 and trained as described above), which can be an LLM, takes as input an image and associated descriptive text with location information 706 or 708 and outputs a response 712 (e.g., an answer) to the question/inquiry that included a natural language instruction. In some embodiments, the answer is exclusively in a form of text. In some embodiments, the answer is played in an audible manner using a speaker attached to a computer. In some embodiments, the answer includes a combination of the generated answer text in visual and/or audible form and at least a portion of the original image. For example, an answer text is overlaid over the original image with the text answer position being chosen to better explain the answer. For example, the answer text is displayed adjacent to the area in question (that was indicated by the pointer).

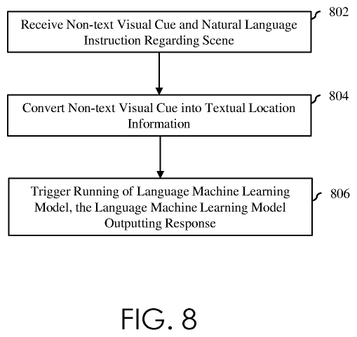

FIG. 8 is a flow diagram illustrating a method of referential dialogue in some embodiments. The method facilitates human-computer interaction that uses non-text cues such as pointers, gestures, or like, in conjunction with natural language instructions, queries and/or prompts. In some embodiments, the method is performed by a processor set. At 802, a processor set receives a non-text visual cue and natural language instruction regarding a scene, e.g., as a part of a human-computer interaction. For example, as described with reference to FIG. 3, human-computer interaction can take place using a device such as a smartphone (302, FIG. 3) running a human-computer interaction user interface. A processor set of such a device may trigger running of a language machine learning model such as a large language model that is trained to facilitate referential dialogue. Examples of the non-text cue include but are not limited to a respective bounding box and a pointer. These non-text cues are typically associated with an image, e.g., are received as being part of, e.g., overlaid over, an image. A non-text cue is also referred to as non-text visual cue.

At 804, a processor set converts the non-text visual cue into textual location information indicating a portion of an image representing the scene. For example, an image segmentation model, e.g., whose use was described with reference to FIG. 4A, can be used to convert the non-text visual cue into a textual location information in an image representing the scene. In another embodiment, graphics programming code is used to produce the textual location information based on the non-text visual cue, e.g., based on position and/or size of a bounding box and/or cursor within an image displayed in a graphics program.

For instance, in some embodiments, the non-text cue includes a bounding box in the image representing the scene, and converting of the non-text cue into a textual location information includes running a machine learning model that associates the bounding box in the image representing the scene with semantic information contained in the bounding box and location coordinates of the bounding box in the image representing the scene. For example, the semantic information contained in the bounding box is associated with the location coordinates of the bounding box with respect to the image. In some embodiments, the machine learning model outputs the semantic information with the location coordinates.

In some embodiments, the non-text cue includes a pointer pointing to an area of the scene. For example, a pointer pointing to an area of the scene can be attained via detecting a mouse pointing to an area of a screen, or a finger touch on a touch screen, and information associated with such a pointer can be received by one or more device drivers on a device used for human-computer interaction such as a smartphone. In such embodiments, converting of the non-text cue into a textual location information includes determining a bounding box that bounds the area of the scene pointed to by the pointer, and running a machine learning model that associates the bounding box with semantic information contained in the bounding box and location coordinates of the bounding box in the image representing the scene. For example, the semantic information contained in the bounding box is associated with the location coordinates of the bounding box with respect to the image. In some embodiments, the machine learning model outputs the semantic information with the location coordinates.

In some embodiments, the machine learning model includes an image segmentation model that segments objects in a given image, correlates bounding boxes of the segmented objects in the given image with respective textual location coordinates of the bounding boxes, and outputs a descriptive text describing the segmented objects with the textual location coordinates corresponding to the bounding boxes of the segmented objects.

At 806, the processor set triggers running of a language machine learning model (e.g., an LLM) using as input at least the textual location information, the natural language instruction, and the image representing the scene, the language machine learning model outputting a response to the input, e.g., an answer to a query posed by the non-text cue and the natural language instruction regarding the scene. For example, the location information, the natural language instruction, and the image representing the scene are input to the language machine learning model for inference, where the language machine learning model outputs a response, e.g., which includes an answer to a query posed by the non-text cue and the natural language instruction regarding the scene. The response is an answer to a question of the input.

In some embodiments, the language machine learning model includes an image encoder and a text encoder, where the language machine learning model is trained based on first embeddings encoded by the image encoder and second embeddings encoded by the text encoder, to relate semantic information appearing in sample images to location information incorporated in sample natural language instructions associated with the sample images.

In some embodiments, the human-computer interaction is performed via a smartphone. A user can use a smartphone to converse or carry on a dialogue to query about a scene. The non-text visual cue is obtained via a human-computer interaction performed via a smartphone.

A model that is built can understand information and use information to connect bounding boxes, visual information and text information. Such model of constructive learning architecture merges all information (text information, bounding box information, and visual information) together, for example, to create a relationship among the information. During training, the model learns that certain bounding box is related to a certain keyword (e.g., “man”) and also to an area or object in an image, hence generating a relation or connection of bounding box information and text. During inference, the model given a location can identify related image and text. For example, the model uses a location as a trigger that identifies related image and text.

A system and/or method presented herein can understand a point or box input by the user, and support the output of point or box, and can seamlessly conduct a reference dialogue with humans. In some embodiments, the system and/or method can be considered unified in design. In some embodiments, the system and/or method adopts a non-splicing design, directly uses numbers to represent coordinates, does not require additional position encoders, front and/or rear target detectors or external plug-in modules, and does not require additional vocabularies.

In some embodiments, the system and/or method enables large language models to engage effectively in action-based dialogue and location-based interactions in diverse scenarios, facilitating non-textual communication and information extraction. In some embodiments, the system and/or method facilitates location understanding and interaction optimization by employing visual processing modules and text processing modules to process input information, generating pointers for large language models to guide attention to specific areas in response to non-textual cues. In some embodiments, the system and/or method provides a comprehensive solution involving location understanding, indicator generation, and interaction optimization, enabling large language models to seamlessly conduct reference dialogues by understanding and responding to point or box inputs without additional position encoders or external plug-in modules. In some embodiments, the system and/or method enables efficient human-LLM interaction in non-textual, location-based scenarios. In some embodiments, the system and/or method facilitates dynamic, action-based exchanges and location-based cues for diverse applications such, as but not limited to, workpiece inspections, text summarization, and document comparison, providing for practical utilization of non-textual cues for real-time decision support and streamlined workflows across industries. In some embodiments, the system and/or method enhances large language models' interaction capabilities using action-based cues and location understanding in real-time, non-textual scenarios for efficient use. In some embodiments, the system and/or method integrates visual and text processing to understand location cues and generates pointers that guide the model's attention to specific areas, allowing seamless interaction through point and/or box inputs and reference dialogue. In some embodiments, the system and/or method enables large language models to interpret and respond to location-based cues, facilitating action-based interactions and enhancing efficiency in diverse scenarios. In some embodiments, the system and/or method integrates location understanding, pointer generation, and interaction optimization to facilitate reference dialogues using large language models, for example, in scenarios demanding non-textual input and real-time information utilization. In some embodiments, the system and/or method integrates visual and text processing modules for location understanding, utilizing semantic representations combined with location data to generate pointers, enabling large language models to attend to specific areas or objects indicated in the dialogue. In some embodiments, the system and/or method augments large language models for dynamic, location-based reference dialogues across various scenarios, for example, involving non-textual cues.

The terminology used herein is for the purpose of describing particular embodiments only and is not intended to be limiting of the invention. As used herein, the singular forms “a”, “an” and “the” are intended to include the plural forms as well, unless the context clearly indicates otherwise. As used herein, the term “or” is an inclusive operator and can mean “and/or”, unless the context explicitly or clearly indicates otherwise. It will be further understood that the terms “comprise”, “comprises”, “comprising”, “include”, “includes”, “including”, and/or “having,” when used herein, can specify the presence of stated features, integers, steps, operations, elements, and/or components, but do not preclude the presence or addition of one or more other features, integers, steps, operations, elements, components, and/or groups thereof. As used herein, the phrase “in some embodiments” does not necessarily refer to the same embodiment, although it may. As used herein, the phrase “in one embodiment” does not necessarily refer to the same embodiment, although it may. As used herein, the phrase “in another embodiment” does not necessarily refer to a different embodiment, although it may. Further, embodiments and/or components of embodiments can be freely combined with each other unless they are mutually exclusive.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A computer-implemented method comprising:
receiving, by a processor set, a non-text visual cue and natural language instruction regarding a scene;
converting, by the processor set, the non-text visual cue into textual location information indicating a portion of an image representing the scene; and
triggering running of a language machine learning model using as input at least the textual location information, the natural language instruction, and the image representing the scene, the language machine learning model outputting a response to the input.

2. The computer-implemented method of claim 1, wherein the non-text visual cue includes a bounding box in the image representing the scene; and
wherein the converting of the non-text visual cue into a textual location information includes running a machine learning model that associates the bounding box with semantic information obtained for an area contained in the bounding box and that outputs location coordinates of the bounding box with respect to the image.

3. The computer-implemented method of claim 2, wherein the machine learning model includes an image segmentation model that segments objects in a given image, correlates bounding boxes of the segmented objects in the given image with respective textual location coordinates of the bounding boxes, and outputs a descriptive text describing the segmented objects via the textual location coordinates.

4. The computer-implemented method of claim 1, wherein the non-text visual cue includes a pointer pointing to an area of the scene; and
wherein the converting of the non-text visual cue into the textual location information includes:
determining a bounding box that bounds the area of the scene pointed to by the pointer; and
running a machine learning model that associates the bounding box with semantic information obtained for an area contained in the bounding box and that outputs location coordinates of the bounding box with respect to the image.

5. The computer-implemented method of claim 4, wherein the machine learning model includes an image segmentation model that segments objects in a given image, correlates bounding boxes of the segmented objects in the given image with respective textual location coordinates of the bounding boxes, and outputs descriptive text describing the segmented objects via the textual location coordinates.

6. The computer-implemented method of claim 1, wherein the language machine learning model includes an image encoder and a text encoder, the language machine learning model having been trained based on first embeddings encoded by the image encoder and second embeddings encoded by the text encoder to relate semantic information appearing in sample images to location information incorporated in sample natural language instructions associated with the sample images.

7. The computer-implemented method of claim 1, wherein the non-text visual cue is obtained via a human-computer interaction performed via a smartphone.

8. The computer-implemented method of claim 1, wherein the response is an answer to a question of the input.

9. A computer program product comprising:
a set of one or more computer-readable storage media;
program instructions, collectively stored in the set of one or more storage media, for causing a processor set to perform the following computer operations:
receive a non-text visual cue and natural language instruction regarding a scene;
convert the non-text visual cue into a textual location information indicating a portion of an image representing the scene; and
trigger running of a language machine learning model using as input at least the textual location information, the natural language instruction, and the image representing the scene, the language machine learning model outputting a response to the input.

10. The computer program product of claim 9, wherein the non-text visual cue includes a bounding box in the image representing the scene; and
for converting the non-text cue, the processor set is caused to run a machine learning model that associates the bounding box with semantic information obtained for an area contained in the bounding box and that outputs location coordinates of the bounding box with respect to the image.

11. The computer program product of claim 10, wherein the machine learning model includes an image segmentation model that segments objects in a given image, correlates bounding boxes of the segmented objects in the given image with respective textual location coordinates of the bounding boxes, and outputs descriptive text describing the segmented objects via the textual location coordinates.

12. The computer program product of claim 9, wherein the non-text visual cue includes a pointer pointing to an area of the scene; and
for converting the non-text cue, the processor set is caused to determine a bounding box that bounds the area of the scene pointed to by the pointer, and run a machine learning model that associates the bounding box with semantic information obtained for an area contained in the bounding box and that outputs location coordinates of the bounding box.

13. The computer program product of claim 12, wherein the machine learning model includes an image segmentation model that segments objects in a given image, correlates bounding boxes of segmented objects in the given image with respective textual location coordinates of the bounding boxes, and outputs descriptive text describing the segmented objects via the textual location coordinates.

14. The computer program product of claim 9, wherein the language machine learning model includes an image encoder and a text encoder, the language machine learning model having been trained based on first embeddings encoded by the image encoder and second embeddings encoded by the text encoder to relate semantic information appearing in sample images to textual location information incorporated in sample natural language instructions associated with the sample images.

15. The computer program product of claim 9, wherein the non-text visual cue is obtained via a human-computer interaction performed via a smartphone.

16. The computer program product of claim 9, wherein the response is an answer to a question of the input.

17. A computer system comprising:
a processor set;
a set of one or more computer-readable storage media;
program instructions, collectively stored in the set of one or more computer-readable storage media, for causing the processor set to perform the following computer operations:
receive a non-text visual cue and natural language instruction regarding a scene;
convert the non-text visual cue into a textual location information indicating a portion of an image representing the scene; and
trigger running of a language machine learning model using as input at least the textual location information, the natural language instruction, and the image representing the scene, the language machine learning model outputting a response to the input.

18. The computer system of claim 17, wherein the non-text text cue includes a bounding box in the image representing the scene; and
for converting the non-text cue, the processor set is caused to run a machine learning model that associates the bounding box with semantic information obtained for an area contained in the bounding box and that outputs location coordinates of the bounding box with respect to the image.

19. The computer system of claim 17, wherein the non-text visual cue includes a pointer pointing to an area of the scene; and
for converting the non-text cue, the processor set is caused to determine a bounding box that bounds the area of the scene pointed to by the pointer, and run a machine learning model that associates the bounding box with semantic information obtained for an area contained in the bounding box and that outputs location coordinates of the bounding box.

20. The computer system of claim 17, wherein the language machine learning model includes an image encoder and a text encoder, the language machine learning model having been trained based on first embeddings encoded by the image encoder and second embeddings encoded by the text encoder to relate semantic information appearing in sample images to textual location information incorporated in sample natural language instructions associated with the sample images.
